(19) United States
(12) Patent Application Publication
(10) Pub. No.: US 2014/0002769 A1
(43) Pub. Date: Jan. 2, 2014

(54) SIDE-EDGE NON-UNIFORM DUTY RATIO BACKLIGHT DRIVING METHOD

(71) Applicant: Kuangyao Chang, Shenzhen (CN)

(72) Inventor: Kuangyao Chang, Shenzhen (CN)

(73) Assignee: SHENZHEN CHINA STAR OPTOELECTRONICS TECHNOLOGY CO., LTD., Shenzhen, Guangdong (CN)

(21) Appl. No.: 13/635,404

(22) PCT Filed: Jul. 12, 2012
(86) PCT No.: PCT/CN12/78532

§ 371 Date: Sep. 15, 2012

(30) Foreign Application Priority Data
Jun. 28, 2012 (CN) 201210218730.X

(51) Int. Cl. G02F 1/13357

(52) U.S. Cl. 349/61

(57) ABSTRACT

A side-edge non-uniform duty ratio backlight driving method includes: conducting a simulation operation of driving a side-edge backlight module on the basis of uniform duty ratio according to predetermined liquid crystal panel signal and backlight scanning timing before an actual operation of driving the backlight module is performed; conducting analysis of the number of zones where an interference signal appears when each backlight sections is lit in the simulative operation and distance of the interference signal and ranking the backlight sections according to strength of cross-talking so that a backlight section having less strong cross-talking is set with a higher rank; and carrying out a driving operation according to predetermined scanning timing of the liquid crystal panel signal and the backlighting in actually driving a side-edge backlight module in such a way that a high duty ratio of backlight driving is set to a high-rank backlight section in lighting.

### BACKGROUND OF THE INVENTION

1. Field of the Invention

The present invention relates to liquid crystal displaying techniques, and in particular to a side-edge non-uniform duty ratio backlight driving method.

2. The Related Arts

The fast development of LED television is now getting into a new era of 3D liquid crystal television. Among the 3D liquid crystal televisions, one of the most commonly used techniques is the shutter glasses 3D displaying technique, in which separate display of signals for left and right eyes is done with sectionalized illumination of backlighting and is used in combination with synchronous flashing of eyeglasses to make the left and right eyes perceiving different images. The shutter glasses 3D displaying technique applies image processing technology to provide a visual effect to human eyes that looks like a stereoscopic movie, which generally comprises alternately supplying signals of left-eye frames and right-eye frames to a liquid crystal panel in order to drive the liquid crystal panel to separately form left-eye images and right-eye images. This, when combined with illumination of a scanning backlight unit and timing control of the shutter glasses, allows the left-eye signals and the right-eye signals to respectively simulate the left eye and the right eye, making a person perceive a 3D image.

However, the 3D liquid crystal display devices have a drawback that since the liquid crystal panel does not emit light by itself, backlighting must be provided to serve as a light source. Due to the consideration of cost factor, sectionalization of the backlight cannot be made very fine. As shown in FIG. 1, a schematic view showing sectionalized lighting and light leakage of a conventional side-edge LED backlight is given. The side-edge LED backlight comprises LED chips that are arranged along circumferential edges of a liquid crystal panel and a light guide plate is included to allow the LED backlight to be lit in a sectionalized manner for conducting light emitting from the circumferential edges of the liquid crystal display panel through the light guide plate to reach a central zone of the liquid crystal display panel. This provides sufficient backlighting entirely, allowing the liquid crystal display panel to display images. The side-edge LED backlight has two advantages. One is that less LED chips can be used and cost is lowered down. The other is that it is possible to make a device body thin by not arranging LED modules on the back side of the liquid crystal panel of LED television but at lateral sides so as to reduce the overall thickness of the liquid crystal panel and thus make the device body extremely thin.

FIG. 1 shows a backlighting section 11 that is of light incidence at a right side short edge. Asymmetry of light leakage is because leakage gets severer with the longer light path. When the backlighting section 11 is lit, light leaks to the sections 12 and 13 on the opposite sides thereof and this causes interference between left-eye and right-eye signals. In other words, the left eye may perceive the signal for the right eye (or the right eye sees the signal for the left eye) and this makes image blurred (for the two signals show distributions that overlap in space). The criterion for assessing image blurring is cross-talking, of which a higher value indicates severer interference. Thus, it is an important issue to reduce cross-talking while maintaining price competitiveness for products.

The cross-talking occurring between a left-eye signal and a right-eye signal of the conventional shutter glasses 3D displaying technique is determined by the technical nature thereof. The backlight module of the conventional shutter glasses liquid crystal 3D display is arranged to form an even number of backlighting sections by dividing a horizontal block in a vertical direction and scanning is carried out from top to bottom to sequentially control activation and operation time for each backlighting section of the backlight module. Image signals (left-eye signals and right-eye signals) sequentially supply, from top to bottom, driving voltages to each row of the liquid crystal panel. Only after pixels receive and are charged by the driving voltages, the liquid crystal panel starts to respond. Due to the design of pixel and the viscosity of liquid crystal, a complete steady state can only be reached after a period of liquid crystal response time. Since liquid crystal responds slowly, image signals are displayed on a liquid crystal panel in a sectionalized scanning fashion. When an image signal scans one of the sections of the liquid crystal panel, the corresponding section of backlight will be set on and the remaining backlight sections are off. Since leakage exists in the backlight sections, when light leaking from a backlight section corresponding to a left-eye signal irradiates a backlight section corresponding to a right-eye signal (or when light leaking from a backlight section corresponding to a right-eye signal irradiates a backlight section corresponding to a left-eye signal), the eyes will simultaneously perceive the left-eye image and the right-eye image, causing cross-talking. The right-eye signal or the left-eye signal that causes cross-talking will be referred to as an error signal (or interference signal).

As shown in FIGS. 2A and 2B, schematic views illustrating sectionalized lighting of backlight for a 46-inch single short edge side-edge LED television are given. Taking the 46-inch single short edge side-edge LED television as an example, the backlight module 20 is often divided into an even number backlight sections, such as four sections, for sectionalized lighting. An edge side backlight section 21, once lit, leaks toward the middle, while a middle backlight section 22, once lit, leaks toward opposite sides.

As shown in FIG. 3, a schematic view showing nine points on a liquid crystal panel where cross-talking is measured. In FIG. 3, a display screen 30 has adjacent sizes of which the dimensions are respectively denoted by reference symbols H and V. The nine points, namely point 1, point 2, and point 9, are arranged according to the relative positioning relationship as shown in FIG. 3. The locations of point 1, point 2, and point 9 on the display screen are exactly the locations on the liquid crystal panel. Measurements are made on a conventional LED television with 46-inch single short edge incidence and four backlight section scanning and the detected cross-talks at the nine points of point 1, point 2, and point 9 are listed in the following Table 1, which clearly indicates that the cross-talking shows a characteristic of vertical asymmetry, with the upper side being much severer than the lower side. In addition, these cross-talks also show horizontal asymmetry. This is caused by the single short edge incidence, where the further the optic path goes, the severer the leakage will be

TABLE 1
Cross-Talks Measured at Nine Points (46″ single short side
incidence and four backlight section scanning)

| single short edge incidence | Left 1/9 | Middle 1/2 | Right 8/9 |
|---|---|---|---|
| Upper 1/9 | 14.99% | 8.84% | 7.03% |
| Middle 1/2 | 5.60% | 4.51% | 3.69% |
| Lower 8/9 | 8.47% | 6.20% | 4.81% |

Due to the arrangement of backlight sections, timing coordination among liquid crystal panel signals, glasses signals, and backlight scanning often result in asymmetry of cross-talking. The data of Table 1 reveal that for a conventional 46-inch single short edge side-edge LED television, the left-eye signal or the right-eye signal shows an image of the best quality on the middle portion of the liquid crystal panel and the quality of image displayed on the liquid crystal panel is generally unsymmetrical in the vertical direction. The vertical asymmetry of cross-talking shown in Table 1 can be explained with the timing relationship between the backlight sections and the liquid crystal panel signals. As shown in FIG. 4, a schematic view is given to illustrate the timing relationship (a left-eye signal being used for demonstration) between the backlight sections of a conventional 46-inch single short edge side-edge LED television and the liquid crystal panel signals (the left-eye image and the right-eye image signal applied to the liquid crystal panel). The backlight module is divided, sequentially from top to bottom, into a first backlight section 41, a second backlight section 42, a third backlight section 43, and a fourth backlight section 44, which respectively function to illuminate first, second, third, and fourth display sections of a liquid crystal panel 40. In FIG. 4, a left-eye signal is taken as an example for demonstrating four successive steps of the operations of the liquid crystal panel 40 and the backlight module for displaying liquid crystal panel signals: step a, in which the first to third display sections are loaded with a left-eye signal of the current frame and the fourth display section is loaded with a right-eye signal of the previous frame; the first backlight section 41 is lit to illuminate the first display section and since leakage from the first backlight section 41 might undesirably illuminate the fourth display section, the right-eye signal of the previous frame loaded in the fourth display section becomes an error signal of cross-talking with the left-eye signal of the current frame loaded in the first display section; since the first display section and the fourth display section are spaced from each other by two display sections therebetween and the distance is great, the cross-talking so caused is minor; step b, in which the fourth display section is also loaded with the left-eye signal of the current frame so that at this moment, the liquid crystal panel 40 is entirely loaded with the left-eye signal; the second backlight section 42 is lit to illuminate the second display section; at this moment, leakage from the second backlight section 42 does not cause cross-talking between the left-eye signal and the right-eye signal, providing the best image quality; step c, in which the first display section is loaded with a right-eye signal of the next frame and the second to fourth display sections are loaded with the left-eye signal of the current frame; the third backlight section 43 is lit to illuminate the third display section; at this moment, the right-eye signal of the next frame loaded in the first display section becomes an error signal of cross-talking with the left-eye signal of the current frame loaded in the third display section; since the first display section and the third display section are only spaced by one display section therebetween and the distance is short, the cross-talking is severe; and step d, in which the first and second display sections are loaded with the right-eye signal of the next frame and the third and fourth display sections are loaded with the left-eye signal of the current frame; the fourth backlight section 44 is lit to illuminate the fourth display section; at this moment, the right-eye signal of the next frame loaded in the first and second display sections becomes an error of cross-talking with the left-eye signal of the current frame loaded in the fourth display section; since the first and second display sections are spaced from the fourth display section by only one display section therebetween and the distance is short, the cross-talking is severe. During the entire process of 3D displaying, the liquid crystal panel 40 repeats the processes of loading a right-eye signal (the previous frame), loading a left-eye signal (the current frame), loading a right-eye signal (the next frame), loading a left-eye signal, loading a right-eye signal, and so on. Since the conventional side-edge backlight sections are set up for sections of even number, when an error signal appears, the influence it imposes on the upper and lower sides is different. In this example, the error signal generated when a backlight section is lit is closer to the upper side and the upper side cross-talking is severe in the liquid crystal panel 40 so that the cross-talking of the liquid crystal panel 40 is unsymmetrical in the vertical direction. Adjustment may be directly made on the liquid crystal panel signal to make backlight section lit at a center of the liquid crystal panel signal. Although the cross-talking of the liquid crystal panel 40 can be made substantially symmetric in the vertical direction, yet due to the number of the backlight sections being even, the quality of image at the center position will be sacrificed and cross-talking gets serious.

### SUMMARY OF THE INVENTION

Thus, an object of the present invention is to use liquid crystal panel signals and backlight section scanning timing to determine the influence on cross-talking caused by each of the backlight sections so that cross-talked display quality can be improved through varying the driving duty ratios of the backlight sections.

To achieve the object, the present invention provides a side-edge non-uniform duty ratio backlight driving method, which comprises the following steps:

Step 1: conducting a simulation operation of driving a side-edge backlight module on the basis of uniform duty ratio according to predetermined liquid crystal panel signal and backlight scanning timing before an actual operation of driving the backlight module is performed;

Step 2: conducting analysis of the number of zones where an interference signal appears when each of backlight sections is lit in the simulative driving operation of the side-edge backlight module and distance of the interference signal and ranking the backlight sections according to strength of cross-talking caused by the interference signal when each of the backlight sections is lit so that a backlight section having less strong cross-talking is set with a higher rank; and

Step 3: carrying out a driving operation according to predetermined scanning timing of the liquid crystal panel signal and the backlighting in actually driving a side-edge backlight module in such a way that a high duty ratio of backlight driving is set to a high-rank backlight section in lighting.

Wherein, the backlight sections of the side-edge backlight module are of an odd number and lighting of the backlight is selected to be constantly set at center of the liquid crystal panel signal in order to minimize cross-talking.

Wherein, the number of the backlight sections of the side-edge backlight module is five and in an actual operation of driving the side-edge backlight module, the third backlight section has the maximum driving duty ratio, the second and fourth backlight sections have the second maximum driving duty ratio, and the first and fifth backlight sections have the third maximum driving duty ratio.

Wherein, the backlight sections of the side-edge backlight module are of an even number and lighting of the backlight is selected to be constantly set at the second section of the liquid crystal panel signal in order to minimize cross-talking at the center.

Wherein, the number of the backlight sections of the side-edge backlight module is four and in an actual operation of driving the side-edge backlight module, the second backlight section has the maximum driving duty ratio, the first backlight section has the second maximum driving duty ratio, the third backlight section has the third maximum driving duty ratio, and the fourth backlight section has the fourth maximum driving duty ratio.

Wherein, the liquid crystal panel signal is a left-eye liquid crystal panel signal or a right-eye liquid crystal panel signal.

Wherein, the side-edge backlight module is of single short edge incidence.

Wherein, the side-edge backlight module is of two short edge incidence.

The present invention also provides a side-edge non-uniform duty ratio backlight driving method, which comprises the following steps:

Step 1: conducting a simulation operation of driving a side-edge backlight module on the basis of uniform duty ratio according to predetermined liquid crystal panel signal and backlight scanning timing before an actual operation of driving the backlight module is performed;

Step 2: conducting analysis of the number of zones where an interference signal appears when each of backlight sections is lit in the simulative driving operation of the side-edge backlight module and distance of the interference signal and ranking the backlight sections according to strength of cross-talking caused by the interference signal when each of the backlight sections is lit so that a backlight section having less strong cross-talking is set with a higher rank; and

Step 3: carrying out a driving operation according to predetermined scanning timing of the liquid crystal panel signal and the backlighting in actually driving a side-edge backlight module in such a way that a high duty ratio of backlight driving is set to a high-rank backlight section in lighting;

wherein the backlight sections of the side-edge backlight module are of an odd number and lighting of the backlight is selected to be constantly set at center of the liquid crystal panel signal in order to minimize cross-talking;

wherein the number of the backlight sections of the side-edge backlight module is five and in an actual operation of driving the side-edge backlight module, the third backlight section has the maximum driving duty ratio, the second and fourth backlight sections have the second maximum driving duty ratio, and the first and fifth backlight sections have the third maximum driving duty ratio;

wherein the liquid crystal panel signal is a left-eye liquid crystal panel signal; and

wherein the side-edge backlight module is of single short edge incidence.

The present invention provides a side-edge non-uniform duty ratio backlight driving method, which is applicable to a backlight module with scanning function to improve cross-talking and enhance display quality by using a backlight driving method that is based on non-uniform duty ratios.

### BRIEF DESCRIPTION OF THE DRAWINGS

The technical solution, as well as beneficial advantages, of the present invention will be apparent from the following detailed description of an embodiment of the present invention, with reference to the attached drawings. In the drawings:

FIG. 1 is a schematic view showing sectionalized lighting and leakage of a conventional side-edge LED backlight;

FIGS. 2A and 2B are schematic views illustrating sectionalized backlight lighting of a 46-inch single edge side-edge LED television;

FIG. 3 is a schematic view showing the sites of 9 points on a display screen for measuring cross-talking;

FIG. 4 is a schematic view showing timing relationship between backlight sections of a 46-inch single short edge side-edge LED television and liquid crystal panel signals;

FIGS. 5A and 5B are diagrams illustrating liquid crystal panel signals and backlight scanning timing of a preferred embodiment of the present invention, in which the number of backlight sections used in FIG. 5A is odd, while the number of backlight sections used in FIG. 5B is even;

FIG. 6 is a schematic view illustrating uniform duty ratio and relative size of duty ratio modified according to a preferred embodiment of the present invention, in which the upper portion of FIG. 6 shows an odd number of five backlight sections and the lower portion shows an even number of four backlight sections; and

FIG. 7 is a flow chart showing a side-edge non-uniform duty ratio backlight driving method according to the present invention.

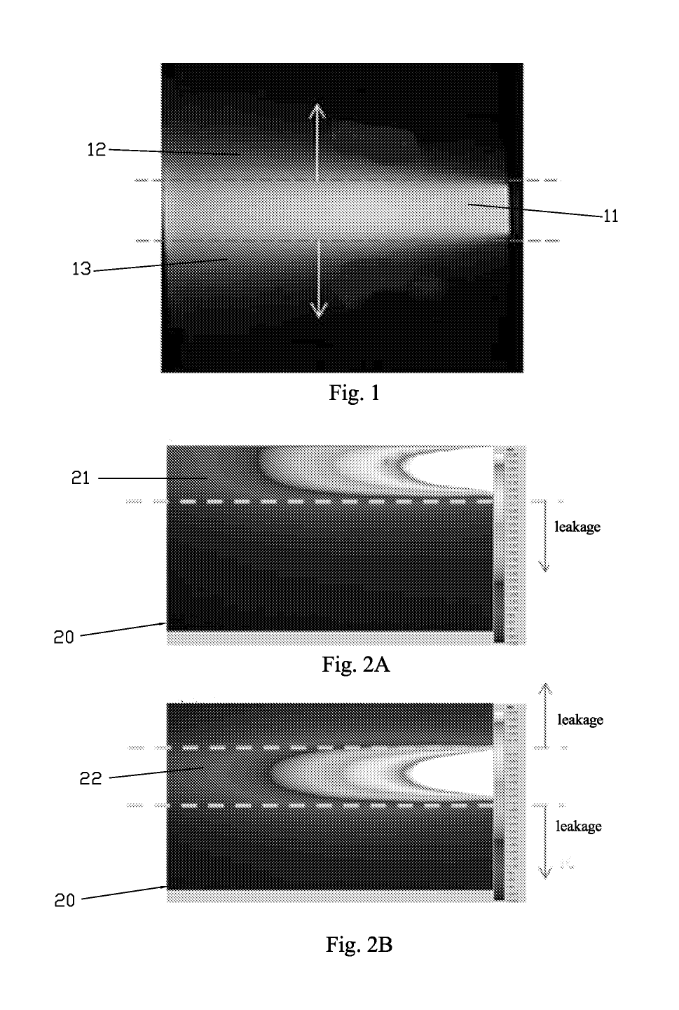

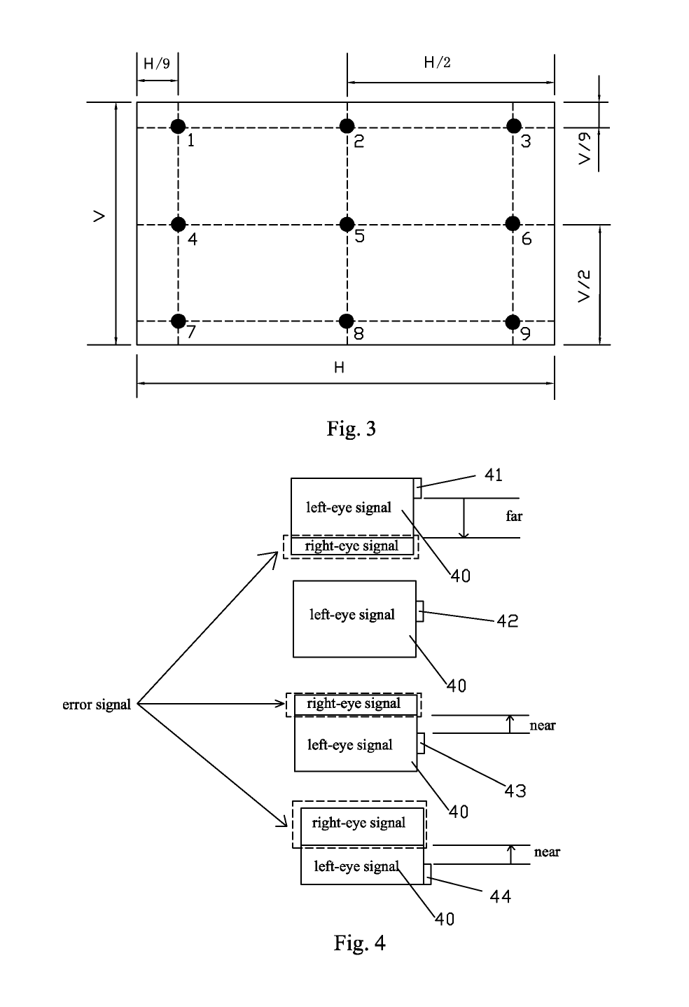

### DETAILED DESCRIPTION OF THE PREFERRED EMBODIMENTS

Referring to FIG. 7, a side-edge non-uniform duty ratio backlight driving method according to the present invention comprises the following step:

Step 1: conducting a simulation operation of driving a side-edge backlight module on the basis of uniform duty ratio according to predetermined liquid crystal panel signal and backlight scanning timing before an actual operation of driving the backlight module is performed;

Step 2: conducting analysis of the number of zones where an interference signal appears when each of backlight sections is lit in the simulative driving operation of the side-edge backlight module and distance of the interference signal and ranking the backlight sections according to strength of cross-talking caused by the interference signal when each of the backlight sections is lit so that a backlight section having less strong cross-talking is set with a higher rank; and

Step 3: carrying out a driving operation according to predetermined scanning timing of the liquid crystal panel signal and the backlighting in actually driving a side-edge backlight module in such a way that a high duty ratio of backlight driving is set to a high-rank backlight section in lighting.

The side-edge backlight module can be of single short edge incidence or two short edge incidence.

The conventional LED backlight driving of liquid crystal displaying is generally of a PWM (Pulse Width Modulation) fashion, in which by adjusting the duty ratio for driving, parameters, such as backlight brightness, can be adjusted. The present invention is provided for application in a liquid crystal panel with a scanning function to improve cross-talking and enhance display quality by applying a backlight driving method that is based on non-uniform duty ratio.

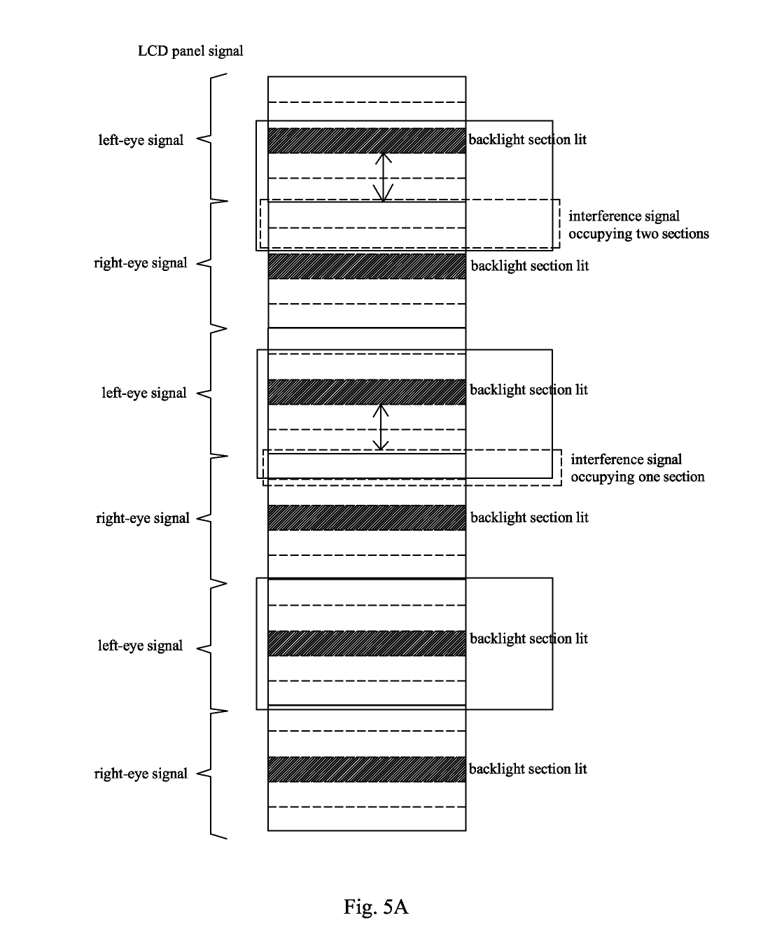

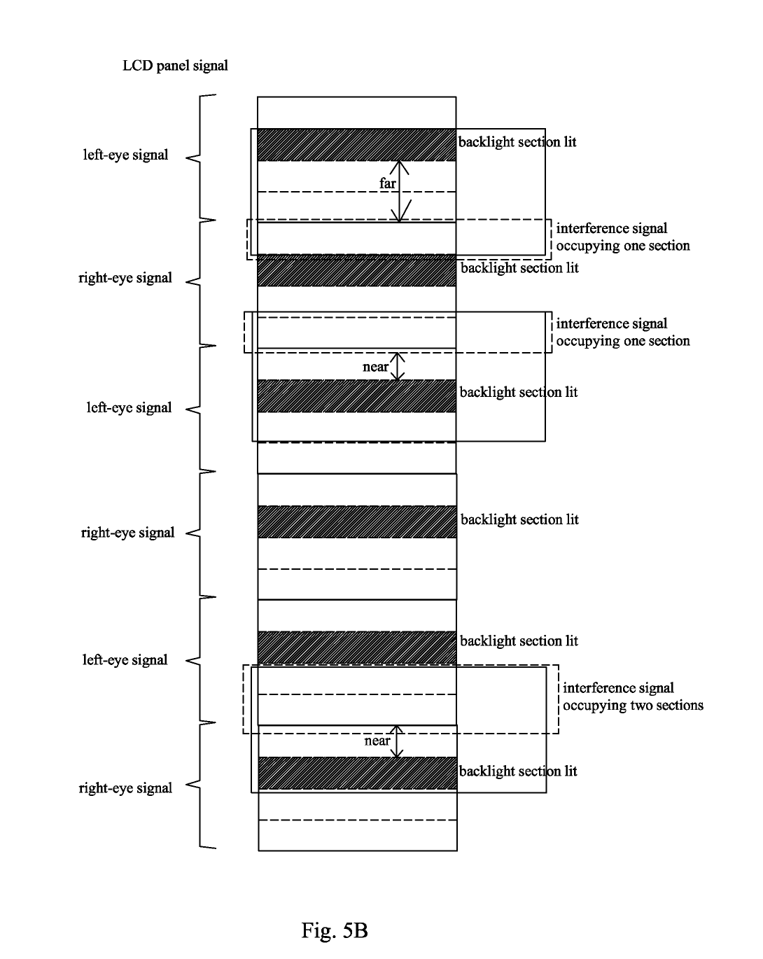

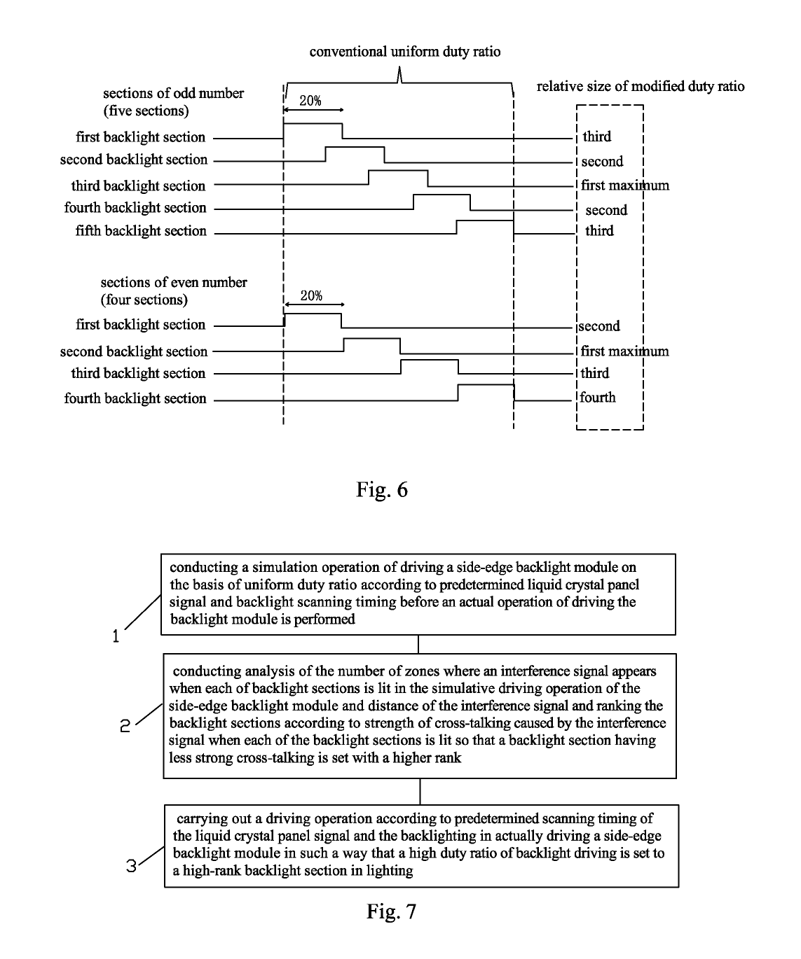

In the following, the side-edge non-uniform duty ratio backlight driving method according to the present invention will be specifically described with reference to FIGS. 5A, 5B, and 6. FIGS. 5A and 5B are diagrams showing liquid crystal panel signals and backlight scanning timing according to a preferred embodiment of the present invention. In FIG. 5A, the number of backlight sections used is an odd number, while in FIG. 5B, the number of backlight sections is even. FIG. 6 is a schematic view illustrating uniform duty ratio and relative size of duty ratio modified according to a preferred embodiment of the present invention. The upper portion of FIG. 6 shows an odd number of five backlight sections and the lower portion shows an even number of four backlight sections.

In FIG. 5A, the number of sections is odd and the left-eye and right-eye liquid crystal panel signals are shown sequentially arranged. The ranges of the left-eye and right-eye signals are indicated by braces. Lighting of the backlight is selected to be constantly set at the center of the liquid crystal panel signal in order to minimize cross-talking. During the cycling process of the liquid crystal panel signals, the first, second, and third sections of backlight are lit separately. The location where the backlight section is lit is indicated by hatching. It is noted from the drawing that the locations, as well as the number thereof, where the interference signals occur are different. In other words, the strength of cross-talking so caused is different, leading to asymmetry of cross-talking. In FIG. 5B, the number of sections is even and the location where the backlight section is lit is indicated by hatching. Lighting of the backlight is set to be constantly at the second section of the liquid crystal panel signal so as to minimize cross-talking at the center. The locations, as well as the number thereof, where the interference signals occur are different, and this leads to asymmetry of cross-talking.

Through analysis conducted on the number of sections where interference signals occur and the distance of the interference signals, the present invention determines the strength of cross-talking and adjusts the duty ratios of the backlight sections corresponding to the signals, so that the duty ratio for driving for backlight sections that when lit induces less strong cross-talking is increased, otherwise the duty ratio is decreased so as to enhance image quality. As shown in FIG. 6, when the number of backlight sections of a side-edge backlight module is five, in an actual operation of driving the side-edge backlight module, the section that is given the maximum duty ratio for driving is the third backlight section and the second and fourth backlight sections are provided with the second maximum duty ratio for driving. The first and fifth backlight sections have the third maximum driving duty ratio. When the number of backlight sections of a side-edge backlight module is four, in an actual operation of driving the side-edge backlight module, the section that is given the maximum driving duty ratio is the second backlight section and the first backlight section is provided with the second maximum driving duty ratio. The third backlight section has the third maximum driving duty ratio. The fourth backlight section has the fourth maximum driving duty ratio.

In summary, the present invention provides a side-edge non-uniform duty ratio backlight driving method, which uses liquid crystal panel signals and backlight scanning timing to determine the influence on cross-talking caused by each of the backlight sections so that cross-talked display quality can be improved through varying the driving duty ratios of the backlight sections.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A side-edge non-uniform duty ratio backlight driving method, comprising the following steps:
(1) conducting a simulation operation of driving a side-edge backlight module on the basis of uniform duty ratio according to predetermined liquid crystal panel signal and backlight scanning timing before an actual operation of driving the backlight module is performed;
(2) conducting analysis of the number of zones where an interference signal appears when each of backlight sections is lit in the simulative driving operation of the side-edge backlight module and distance of the interference signal and ranking the backlight sections according to strength of cross-talking caused by the interference signal when each of the backlight sections is lit so that a backlight section having less strong cross-talking is set with a higher rank; and
(3) carrying out a driving operation according to predetermined scanning timing of the liquid crystal panel signal and the backlighting in actually driving a side-edge backlight module in such a way that a high duty ratio of backlight driving is set to a high-rank backlight section in lighting.

2. The side-edge non-uniform duty ratio backlight driving method as claimed in claim 1, wherein the backlight sections of the side-edge backlight module are of an odd number and lighting of the backlight is selected to be constantly set at center of the liquid crystal panel signal in order to minimize cross-talking.

3. The side-edge non-uniform duty ratio backlight driving method as claimed in claim 1, wherein the number of the backlight sections of the side-edge backlight module is five and in an actual operation of driving the side-edge backlight module, the third backlight section has the maximum driving duty ratio, the second and fourth backlight sections have the second maximum driving duty ratio, and the first and fifth backlight sections have the third maximum driving duty ratio.

4. The side-edge non-uniform duty ratio backlight driving method as claimed in claim 1, wherein the backlight sections of the side-edge backlight module are of an even number and lighting of the backlight is selected to be constantly set at the second section of the liquid crystal panel signal in order to minimize cross-talking at the center.

5. The side-edge non-uniform duty ratio backlight driving method as claimed in claim 4, wherein the number of the backlight sections of the side-edge backlight module is four and in an actual operation of driving the side-edge backlight module, the second backlight section has the maximum driving duty ratio, the first backlight section has the second maximum driving duty ratio, the third backlight section has the third maximum driving duty ratio, and the fourth backlight section has the fourth maximum driving duty ratio.

6. The side-edge non-uniform duty ratio backlight driving method as claimed in claim 1, wherein the liquid crystal panel signal is a left-eye liquid crystal panel signal or a right-eye liquid crystal panel signal.

7. The side-edge non-uniform duty ratio backlight driving method as claimed in claim 1, wherein the side-edge backlight module is of single short edge incidence.

8. The side-edge non-uniform duty ratio backlight driving method as claimed in claim 1, wherein the side-edge backlight module is of two short edge incidence.

9. A side-edge non-uniform duty ratio backlight driving method, comprising the following steps:
(1) conducting a simulation operation of driving a side-edge backlight module on the basis of uniform duty ratio according to predetermined liquid crystal panel signal and backlight scanning timing before an actual operation of driving the backlight module is performed;
(2) conducting analysis of the number of zones where an interference signal appears when each of backlight sections is lit in the simulative driving operation of the side-edge backlight module and distance of the interference signal and ranking the backlight sections according to strength of cross-talking caused by the interference signal when each of the backlight sections is lit so that a backlight section having less strong cross-talking is set with a higher rank; and
(3) carrying out a driving operation according to predetermined scanning timing of the liquid crystal panel signal and the backlighting in actually driving a side-edge backlight module in such a way that a high duty ratio of backlight driving is set to a high-rank backlight section in lighting;
wherein the backlight sections of the side-edge backlight module are of an odd number and lighting of the backlight is selected to be constantly set at center of the liquid crystal panel signal in order to minimize cross-talking;
wherein the number of the backlight sections of the side-edge backlight module is five and in an actual operation of driving the side-edge backlight module, the third backlight section has the maximum driving duty ratio, the second and fourth backlight sections have the second maximum driving duty ratio, and the first and fifth backlight sections have the third maximum driving duty ratio;
wherein the liquid crystal panel signal is a left-eye liquid crystal panel signal; and
wherein the side-edge backlight module is of single short edge incidence.
